(19) United States
(12) Patent Application Publication
(10) Pub. No.: US 2007/0138971 A1
(43) Pub. Date: Jun. 21, 2007

(54) AC-to-DC voltage converter as power supply for lamp

(76) Inventor: Liang Chen, McKinney, TX (US)

Correspondence Address: LIANG CHEN, 5305 Hampshire Drive, McKinney, TX, 75070, US

(21) Appl. No.: 11/706,645

(22) Filed: Feb. 15, 2007

Related U.S. Application Data
(63) Continuation-in-part of application No. 11/204,307, filed on Aug. 15, 2005.

(51) Int. Cl. H05B 39/04

(52) U.S. Cl. 315/209 R

(57) ABSTRACT

An AC-to-DC voltage converter as power supply for lamp converts an AC input voltage to a constant DC voltage at predetermined value set by potentiometer. The converter includes input power supply 210, input protection circuit 201, EMI filter 202, rectifier 203, filter 204, converter 206, output filter 214, lamp 211, start circuit 208, control circuit 209, biasing circuit 212, sampling circuit 207, output protection circuit 200, feedback and dimming circuit 205 and input monitor circuit 213. This version is a flyback converter; versions from other topologies etc are also provided. The converter has feedback function that can regulate output voltage at predetermined value. The converter has dimming function and can adjust lamp brightness for conformability. The output constant brightness decreases peoples' eyes fatigue to minimum level.

This application is a continuation in part of application Ser. No. 11/204,307 filed on Aug. 15, 2005.

### FIELD OF THE INVENTION

The invention is an AC-to-DC converter as lamp power supply that converts an AC input voltage to a constant DC voltage at predetermined value set by potentiometer. The lamp has constant brightness, no low frequency or high frequency flicker light in the output, no electromagnetic radiation, thus reduce eye's fatigue to minimum level and protect eyesight and health to maximum level.

### BACKGROUND OF THE INVENTION

Currently, the power supply for lamp has three main categories:
1) Output has only low frequency (less than a few hundred Hz) voltage;
2) Output has only high frequency (more than a few hundred Hz and usually around KHz) voltage;
3) Output has high frequency voltage in low frequency envelope.

The first category has serious low frequency flicker problem, the crystalline lens and pupil muscle will adjust to the flicker light and become very tired. In the long run, the crystalline and pupil muscle becomes slack and can't adjust accurately then myopia is caused.

The second category has high frequency flicker, the crystalline lens and pupil muscle is not fast enough to adjust at such a high frequency. The intense peak light will hurt retina for long run and dry cornea or opacity of the crystalline lens are caused. High frequency electromagnetic radiation will hurt health.

The third category has low frequency flicker to cause myopia and high frequency flicker to hurt retina or cause electromagnetic radiation that will hurt health.

### SUMMARY OF THE INVENTION

The invention is an AC-to-DC converter as lamp power supply that converts an AC input voltage to a constant DC voltage at predetermined value set by potentiometer. The output lamp has neither low frequency flicker nor high frequency flicker. So the constant brightness light reduces eyes' fatigue to minimum level to prevent myopia. And the constant brightness light can be set to comfortable value that has no intense light to hurt retina by adjusting dimming and feedback circuit. There is no electromagnetic radiation on output.

In order to realize the above object, the invention provides an AC-to-DC voltage converter as power supply for lamp. The converter includes input power supply 210, input protection circuit 201, EMI filter 202, rectifier 203, filter 204, converter 206, output filter 214, lamp 211, start circuit 208, control circuit 209, biasing circuit 212, sampling circuit 207, output protection circuit 200, feedback and dimming circuit 205, input monitor circuit 213.

Input power source 210 is connected to input protection circuit 201, 201 is connected to EMI filter 202, 202 is connected to rectifier 203, 203 is connected to filter 204, 204 is connected to input of converter 206, the output of converter 206 is connected to output filter 214, 214 is connected to lamp 211, the input of sampling circuit 207 is connected to the output of converter 206 or lamp 211, the output of sampling circuit 207 is connected to input of feedback and dimming circuit 205, the output of feedback and dimming circuit 205 is connected to input of control circuit 209, input of start circuit 208 is connected to output of rectifier 203 or the output of filter 204, output of start circuit 208 is connected to input of control circuit 209 or output of biasing circuit 212, input of biasing circuit 212 is connected to output of converter 206 or lamp 211, input of output protection circuit 200 is connected to output of converter 206 or lamp 211, output of output protection circuit is connected to input of control circuit 209, input of input monitor circuit 213 is connected to output of rectifier 203 or output of filter 204, output of input monitor circuit 213 is connected to input of control circuit 209, the output of control circuit 209 is connected with converter 206 input.

The position or connection way of circuit Block 200, 201, 202, 203, 204, 205, 206, 207 208, 209, 210, 211, 212, 213, 214 can be changed, some block can be removed, or new block can be added in or attached. Some block can be integrated into one circuit, part of some block can be integrated with part of another block into one circuit. Every block can use any circuit that has the required function.

In the invention, input voltage source comes from line voltage that is usually low frequency AC voltage such as 110 volt, 60 Hz or 220 volt, 50 Hz; Over current protection circuit becomes open to cut off the connection between voltage source 210 and power supply input when input current is above predetermined value, over voltage protection circuit clamp input voltage under predetermined value to prevent over voltage damage on power supply circuit, they compose input protection circuit 201; EMI filter 202 prevents high frequency component from entering low frequency input power supply 210; rectifier 203 converts AC voltage to varying magnitude DC voltage; filter 204 prevents high frequency component from entering start circuit 208 and control circuit 209; converter 206 converts varying magnitude DC voltage to constant DC voltage; sampling circuit 207 collect voltage signal proportional to output voltage; Feedback and dimming circuit 205 regulates output voltage at constant value while changes output voltage and dims lamp by changing potentiometer resistor value to change the ratio between output voltage and interior reference voltage in control circuit 209; control circuit 209 control turn on time or switching frequency of the main switch in converter 206 to regulate the output voltage at a constant value or use other control way such as pulse train control or DSP; Output filter 214 prevents high frequency component from entering output lamp; start circuit 208 supplies power to control circuit 209 to startup the power supply before stable operation, after the power supply enter stable state, the start circuit 208 is reverse biased and doesn't work and biasing circuit 212 supply power to control circuit 209, some circuit can use biasing circuit 212 to supply power to control circuit 209 from very beginning to stable state; lamp 211 can use any kind of lamp; output protection circuit 200 can have over voltage protection circuit, over current protection circuit, over temperature protection circuit, when output voltage, output current or board temperature is above predetermined value, control circuit 209 turns off the main switch in voltage converter 206; input monitor circuit 213 monitor the input voltage and send the signal to control circuit 209 to control duty cycle or frequency response to input voltage in order that the output voltage is regulated at constant predetermined value.

### BRIEF DESCRIPTION OF THE DRAWINGS

FIG. 1 the block diagram of the invention;

FIG. 2 one implementation of the invention, Flyback topology used as converter 206, integrated circuit controller IW2202 for control circuit 209; feedback is realized with auxiliary winding;

FIG. 3 one implementation of the invention, Flyback topology used as converter 206, integrated circuit controller IW2210 for control circuit 209; feedback is realized with auxiliary winding;

FIG. 4 one implementation of the invention, Flyback topology used as converter 206, integrated circuit controller IW1688 for control circuit 209; feedback is realized with auxiliary winding;

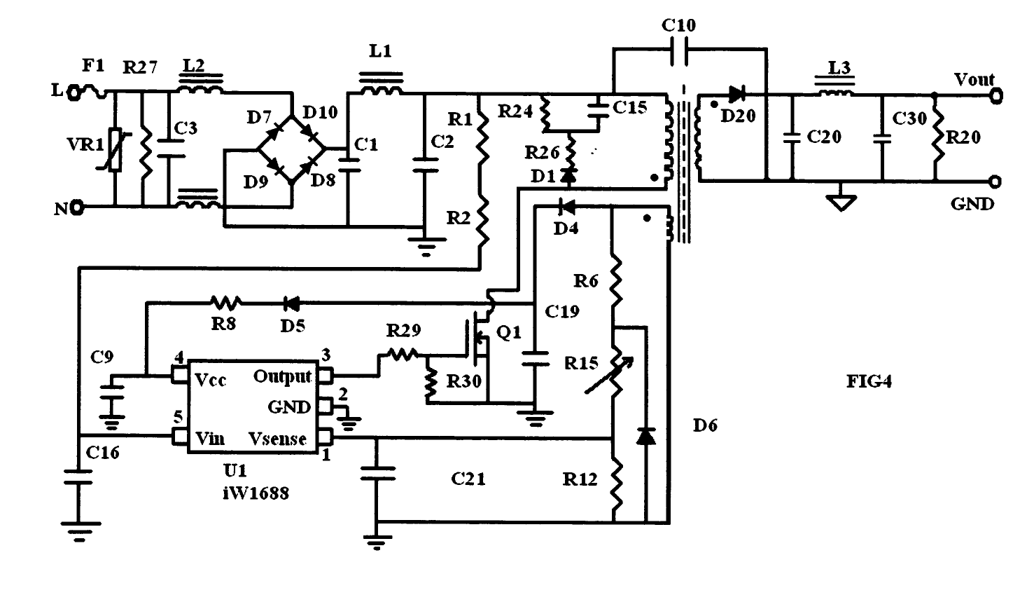

FIG. 5 one implementation of feedback with opto-coupler, R15 is a potentiometer, R6 and R31 are resistors, point 1 is connected to Vo, point 2 is connected to Vref or Vreg, point 3 is connected to Vsense or feedback pin.

FIG. 6 one implementation with DC fluorescent lamp, resistor Rs and Capacitor Cs delay voltage change, Ts is the trigger to connect the cathode filament, after lamp start, voltage goes down and Ts disconnect the cathode filament.

### DETAILED DESCRIPTION OF THE INVENTION

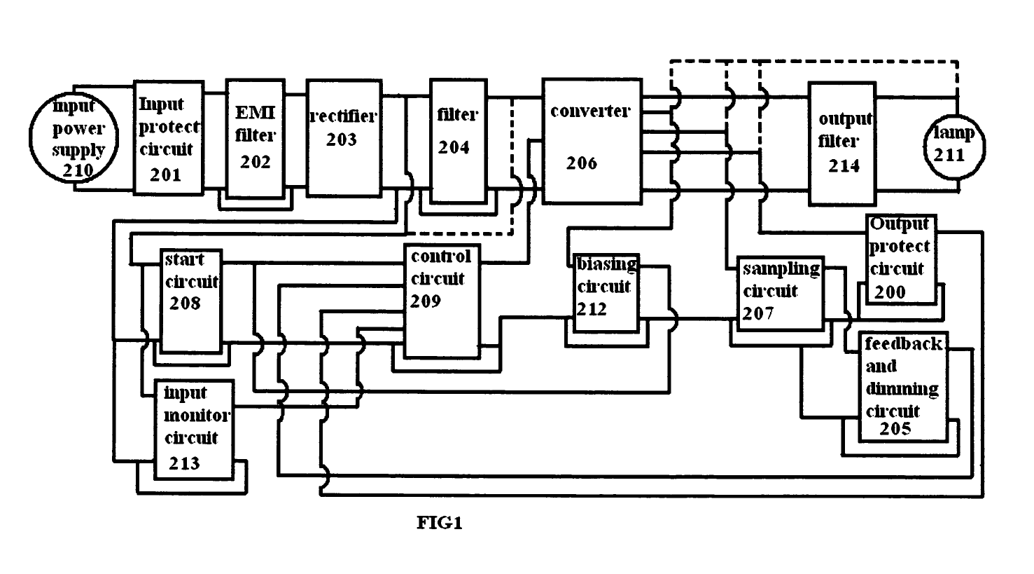

In FIG. 1, input voltage comes from line voltage that is usually sinusoidal AC voltage, rectifier 203 converts AC sinusoidal voltage to DC sinusoidal voltage, converter 206 converts DC sinusoidal voltage to a DC constant voltage on output.

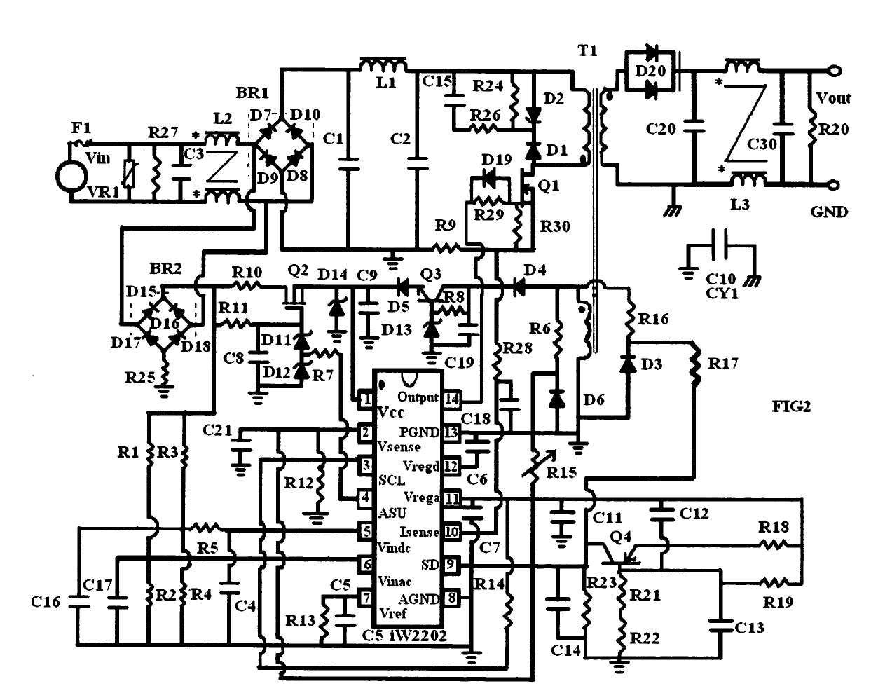

FIG. 2 is one implementation of the invention, input power supply 210 comes from line voltage usually around 100 volt 60 Hz AC voltage; Fuse F1 works as input over current protection circuit, transient absorber VR1 works as input over voltage protection circuit, F1,VR1 constitute input protection circuit 201; inductor L2 common mode filter and capacitor C3 form the EMI filter 202, resistor R27 can discharge capacitor C3; diodes D7,D8,D9,D10 compose bridge rectifier BR1, diodes D15,D16,D17,D18 compose bridge rectifier BR2, BR1 or BR2 or both become rectifier circuit 203, resistor R25 is the limiting current resistor; π filter composed of capacitors C1,C2 and inductor L1 works as filter 204; transformer T1, transistor Q1, diode D20 constitute Flyback topology converter that works as converter 206, clamp circuit D2, diode D1, resistor R24,R26, capacitor C15 clamp the spike voltage on the drain of transistor Q1, resistor R30 prevents transistor Q1 from turning on by static electricity; common mode filter L3 and capacitor C20,C30 constitute output filter 214, resistor R20 discharge capacitor C20,C30; auxiliary winding of transformer T1 and diode D6 constitute sampling circuit 207; resistor R6,R12 and potentiometer R15 constitute feedback and dimming circuit 205, capacitor C21 remove noise signal; integrated circuit Iw2202 works as control circuit 209, resistor R29 and diode D19 control delay time of turn on duration; resistors R10,R11,R7, transistor Q2, capacitor C8, zener diodes D11,D12 constitute start circuit 208; auxiliary winding, diodes D4,D5, transistor Q3, resistor R8, zener diodes D13,D14, capacitors C9,C19 constitute biasing circuit 212; lamp 211 can use any lamp such as Halogen, Incandescent or DC fluorescent etc; auxiliary winding, resistors R16,R17,R23 and diode D3 constitute output over voltage protection circuit, capacitors C11,C12,C13,C14 and resistors R18,R19,R21, NTC thermistor R22 and transistor Q4 constitute over temperature protection circuit, resistor R9, filter R28, C18 constitute over current protection circuit, as above, three circuits compose output protection circuit 200; capacitor C16,C17, voltage divider resistors R1,R2,R3,R4, filter resistor R5, capacitor C4 compose input monitor circuit 213; the following describes the connection with IC controller Iw2202.

Output of start circuit 208 and output of biasing circuit 212 are connected to pin1-Vcc; output of feedback and dimming circuit 205 is connected to pin2-Vsense; pin3-SCL is secondary current limit feedback input, it is connected to pin11-Vrega by a 10 Kohm resistor when secondary current limit is not used; zener diode D12 of start circuit 208 is connected to pin4-ASU by resistor R7; the input monitor circuit 213 get signal proportional to line voltage by voltage divider R3 and R4 then sends to pin5-Vindc with filter composed of resistor R5 and capacitor C4, monitor signal reflects the average voltage of line voltage and is used as under voltage protection and over voltage protection; input monitor circuit 213 gets signal proportional to line voltage by voltage divider R1,R2 and sends to pin6-Vinac for power factor correction to make current and voltage waveform in phase; resistor R13 and capacitor C5 are connected to pin7-Vref 2.0 volt reference voltage output; pin8-AGND analog circuit ground; pin9-SD samples input signal at every switching pulse, when sampling signal is higher than threshold voltage, converter turns off in unlatch mode, it can be used as over voltage protection, over temperature protection; the voltage across R9 is sent to pin10-Isense that is used as main switch current limit, that can be used for single pulse current limit, over current protection or short circuit protection; capacitor C7 is connected to pin11-Vrega that is analog regulator output; capacitor C6 is connected to pin12-Vregd that is digital regulator output; pin13-PGND is power ground and grounded; pin14-ouput pulse signal to drive transistor Q1; capacitor C10 is a Y capacitor that is connected between primary and secondary side of transformer.

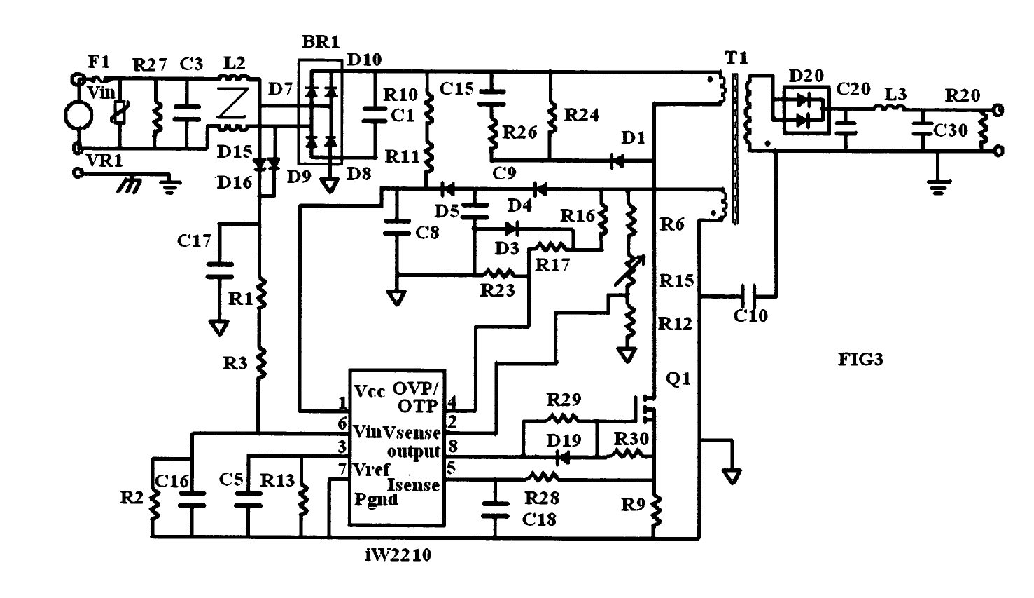

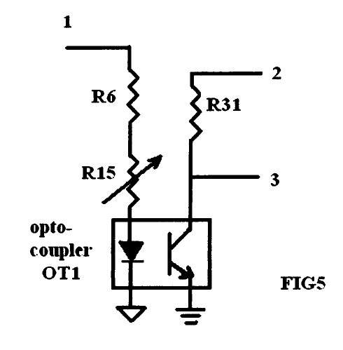

Another implementation is shown in FIG. 3, 4 respectively, same name component has same function, connection way is similar to FIG. 2. FIG. 2, 3, 4 use auxiliary winding as feedback, potentiometer is on primary side; opto-coupler can be used in FIG. 2, 3, 4 for feedback, potentiometer is on secondary side. One implementation with opto-coupler feedback is shown in FIG. 5.

The principle of the implementations is as the following:

When main switch Q1 turns on, the energy is saved in primary winding of transformer, after main switch Q1 turns off, the energy is transferred to secondary and lamp;

Output voltage Vo, input voltage Vg(t), duty cycle D, D′=1−D, n is the ratio between primary and secondary winding, so
Vo=Vg(t)*D/(D′*n) (1)
Vg(t) is the DC sinusoidal voltage after rectifier 203, rms value of line voltage is Vrms(t), so w=2*π*f, f is input voltage frequency,
Vg(t)=1.414*Vinrms*|sin(wt)| (2)
Substitute Vg(t), we get D(t)=1/(1+1.414*Vinrms*|sin(wt)|/(n*Vo)) (3)

From (3), we know duty cycle D(t) an be adjusted according to Vg(t) in order to get constant predetermined value Vo. The frequency also can be adjusted to get constant predetermined value Vo. Pulse Train control or smart skip mode can also be used such as iW2210 or iW1688.

Dimming is realized by changing resistance of potentiometer R15, Naux is turns of auxiliary winding, Ns is turns of secondary winding, according to FIG. 2, Vsense=Vo*R12*Naux/((R6+R15+R12)*Ns).

Controller keeps Vsense=Vref.
Vo=Vref*(R6+R15+R12)*Ns/(R12*Naux)=Vref*(1+(R6+R15)/R12)*Ns/Naux

Here Vref, Ns, Naux, R6 and R12 are all constant values, R15 value can be changed. Vo will be changed according to R15 change. So we can change R15 value to change output voltage value and also lamp brightness.

In one implementation, power factor correction is realized by adjusting input average current ipr(t)av to be in phase with input voltage Vin(t), power factor is almost 1.

The power supply can be implemented as the following:

Filter 202,204,214 can use common mode filter, differential mode filter, LC, CLC filter; rectifier 203 can use full bridge rectifier, half bridge rectifier, bridge less PFC etc; converter 206 can use any topology as the following: Buck, Boost, Buck-boost, Noninverting buck-boost, H-Bridge, Watkins-Johnson, Current-fed bridge, Inverse of Watkins-Johnson, Cuk, SEPIC, Inverse of SEPIC, Buck square, full bridge, half bridge, Forward, Two-transistor Forward, Push-pull, Flyback, Push-pull converter based on Watkins-Johnson, Isolated SEPIC, Isolated Inverse SEPIC, Isolated Cuk, Two-transistor Flyback etc; sampling circuit 207 can use auxiliary winding or optocoupler or sampling voltage from the lamp; feedback and dimming circuit 205 can use voltage divider composed of resistor and potentiometer or voltage divider composed of potentiometer and reference voltage; the control circuit 209 in the power supply control suitable topology to convert sinusoidal voltage after rectified to constant DC voltage, Flyback topology can use iW2202, iW2210, iW1688, UCC28600, LNK362, LNK363, LNK364, TinySwitch, TOPSwitch, PeakSwitch, VIPer series, TEA1506,NCP1055,FSDM311,IRIS series etc IC controller; Buck or Buck-Boost topology can use LNK302,LNK304,LNK305,LNK306 etc IC controller;When using other controller or other topology, circuit maybe different from FIG. 2, circuit 209 can use any controller, IC controller or discrete component controller.

Start circuit 208 can use linear regulator or valley-filled circuit etc; biasing circuit 212 can use auxiliary winding or zener diode; lamp 211 can use any lamp such as Halogen, incandescent, fluorescent etc; input power supply 210 usually comes from 11 volt AC 60 Hz or 220 volt AC 50 Hz. Output protection circuit 200 can have over voltage protection, over current protection, over temperature protection or other protection, it can be realized by other circuit, the power supply can have one or several protection circuits mentioned above.

Many types of method have been described. But all the changes don't run away from main idea. That is the power supply that can convert from low frequency line AC voltage to DC constant voltage which has no low frequency component or high frequency component, which reduces eye's fatigue to minimum level and has no electromagnetic radiation. The invention prevents myopia and protects people's health to maximum level. The invention can be used as bus AC to DC converter, PFC converter, PFC converter for lighting, computer power supply, TV power supply, monitor power supply, notebook adapter, LCD TV, AC/DC adapter, battery charger, power tool charger, electronic ballast, video game power supply, router power supply, ballast, power tool charge power supply etc.

1. An AC-to-DC voltage converter as power supply for lamp includes input power supply 210, input protection circuit 201, EMI filter 202, rectifier 203, filter 204, converter 206, output filter 214, lamp 211, start circuit 208, control circuit 209, biasing circuit 212, sampling circuit 207, output protection circuit 200, feedback and dimming circuit 205 and input monitor circuit 213, its character is converting an AC input voltage to a constant DC voltage at predetermined value set by potentiometer; the lamp has constant brightness that reduces eyes' fatigue to minimum level, the lamp is dimmable by changing potentiometer, the power supply doesn't include electromagnetic radiation and protects people's eyesight and health to maximum level;
Input power supply 210 is connected to input protection circuit 201, 201 is connected to EMI filter 202, 202 is connected to rectifier 203, 203 is connected to filter 204, 204 is connected to input of converter 206, the output of converter 206 is connected to output filter 214, 214 is connected to lamp 211, the input of sampling circuit 207 is connected to the output of converter 206 or lamp 211, the output of sampling circuit 207 is connected to input of feedback and dimming circuit 205, the output of feedback and dimming circuit 205 is connected to input of control circuit 209, input of start circuit 208 is connected to output of rectifier 203 or the output of filter 204, output of start circuit 208 is connected to input of control circuit 209 or output of biasing circuit 212, input of biasing circuit 212 is connected to output of converter 206 or lamp 211, input of output protection circuit 200 is connected to output of converter 206 or lamp 211, output of output protection circuit 200 is connected to input of control circuit 209, input of input monitor circuit 213 is connected to output of rectifier 203 or output of filter 204, output of input monitor circuit 213 is connected to input of control circuit 209, the output of control circuit 209 is connected to input of converter 206;
The position or connection way of circuit block 200, 201, 202, 203, 204, 205, 206, 207, 208, 209, 210, 211, 212, 213, 214 can be changed, some block can be removed, or new block can be added in or attached; some block can be integrated into one circuit, part of some block can be integrated with part of another block into one circuit; every block can use any circuit that has the required function.

2. An AC-to-DC voltage converter as power supply for lamp according to claim 1, wherein input voltage supply comes from line voltage that is usually low frequency AC voltage such as 110 volt, 60 Hz or 220 volt, 50 Hz; over current protection circuit becomes open to cut off the connection between input voltage supply 210 and power supply input when input current is above predetermined value, over voltage protection circuit clamp input voltage under predetermined value to prevent over voltage damage on power supply circuit, they compose input protection circuit 201; EMI filter 202 prevents high frequency component from entering low frequency input power supply 210; rectifier 203 converts AC voltage to varying magnitude DC voltage; filter 204 prevents high frequency component from entering start circuit 208 and control circuit 209; converter 206 converts varying magnitude DC voltage to constant DC voltage; sampling circuit 207 collect voltage signal proportional to output voltage; feedback and dimming circuit 205 regulates output voltage at constant value while changes output voltage and dims lamp by changing potentiometer resistor value to change the ratio between output voltage and interior reference voltage in control circuit 209; control circuit 209 control turn on time or switching frequency of the main switch in converter 206 to regulate the output voltage at a constant value; output filter 214 prevents high frequency component from entering output lamp; start circuit 208 supplies power to control circuit 209 to startup the power supply before stable operation, after the power supply enter stable state, the start circuit 208 is reverse biased and doesn't work and biasing circuit 212 supply power to control circuit 209, some circuit can use biasing circuit 212 to supply power to control circuit 209 from very beginning to stable state; lamp 211 can use any kind of lamp; output protection circuit 200 can have over voltage protection circuit, over current protection circuit, over temperature protection circuit, when output voltage, output current or board temperature is above predetermined value; control circuit 209 turns off the main switch in voltage converter 206; input monitor circuit 213 monitor the input voltage and send the signal to control circuit 209 to control duty cycle or frequency response to input voltage in order that the output voltage is regulated at constant predetermined value.

3. An AC-to-DC voltage converter as power supply for lamp according to claim 1, wherein one implementation is shown in FIG. 2, 3, 4, input power supply 210 comes from line voltage usually around 110 volt 60 Hz AC voltage; fuse F1 works as input over current protection circuit, transient absorber VR1 works as input over voltage protection circuit, F1 and VR1 constitute input protection circuit 201; inductor L2 common mode filter and capacitor C3 form the EMI filter 202, resistor R27 can discharge capacitor C3; diodes D7, D8, D9, D10 compose bridge rectifier BR1, diodes D15,D16,D17,D18 compose bridge rectifier BR2, BR1 or BR2 or both become rectifier circuit 203, resistor R25 is the limiting current resistor; π filter composed of capacitors C1,C2 and inductor L1 works as filter 204; transformer T1, transistor Q1,diode D20 constitute Flyback topology converter that works as converter 206, voltage clamping circuit D2, diode D1, resistor R24,R26, capacitor C15 clamp the spike voltage on the drain of transistor Q1, resistor R30 prevents transistor Q1 from turning on by static electricity; common mode filter L3 and capacitor C20,C30 constitute output filter 214, resistor R20 discharge capacitor C20,C30; auxiliary winding of transformer T1 and diode D6 constitute sampling circuit 207; resistor R6,R12 and potentiometer R15 constitute feedback and dimming circuit 205, capacitor C21 remove noise signal; integrated circuit Iw2202 works as control circuit 209, resistor R29 and diode D19 control delay time of turn on duaration; resistors R10,R11,R7, transistor Q2, capacitor C8, zener diodes D11,D12 constitute start circuit 208; auxiliary winding, diodes D4,D5, transistor Q3, resistor R8, zener diodes D13,D14, capacitors C9,C19 constitute biasing circuit 212; lamp 211 can use any lamp like Halogen, Incandescent or DC fluorescent etc; auxiliary winding, resistors R16,R17,R23 and diode D3 constitute output over voltage protection circuit, capacitors C11,C12,C13,C14 and resistors R18,R19,R21, NTC thermistor R22 and transistor Q4 constitute over temperature protection circuit, resistor R9, filter composed of R28, C18 constitute over current protection circuit, as above, three circuits compose output protection circuit 200; capacitor C16,C17, voltage divider resistors R1, R2, R3, R4, filter resistor R5, capacitor C4 compose input monitor circuit 213; other circuits with similar function can be used for the AC-to-DC voltage converter as power supply for lamp.

4. An AC-to-DC voltage converter as power supply for lamp according to claim 1, wherein the lamp can use any kind lamp, such as Halogen, Incandescent, LED, PAR, miniature sealed beam lamp, Projection lamp, Automotive lamp, stage and studio lamp, DC fluorescent, DC compact, phosphorescent OLED, fluorescent OLED, OLED, Fluorescent, HID, Compact, metal halide lamp etc.

5. An AC-to-DC voltage converter as power supply for lamp according to claim 1, wherein the converter output voltage can change polarity periodically if the output lamp uses fluorescent.

6. An AC-to-DC voltage converter as power supply for lamp according to claim 1, wherein the converter 206 converter DC sinusoidal voltage to predetermined DC constant voltage, the topology can use any structure as the following: Buck, Boost, Buck-boost, Noninverting buck-boost, H-Bridge, Watkins-Johnson, Current-fed bridge, Inverse of Watkins-Johnson, Cuk, SEPIC, Inverse of SEPIC, Buck square, full bridge, half bridge, Forward, Two-transistor Forward, Push-pull, Flyback, Push-pull converter based on Watkins-Johnson, Isolated SEPIC, Isolated Inverse SEPIC, Isolated Cuk, Two-transistor Flyback etc or any other topology that can convert a varying magnitude DC voltage after rectified to predetermined DC constant voltage.

7. An AC-to-DC voltage converter as power supply for lamp according to claim 1, wherein the controller 209 control the suitable topology, convert from rectified sinusoidal voltage to predetermined DC constant voltage, Flyback can use iW2202, iW2210, iW1688, UCC28600, LNK362, LNK363, LNK364, TinySwitch series, TOPSwitch series, PeakSwitch series, VIPer series etc IC controllers; Buck or Buck-Boost topology can use LNK302, LNK304, LNK305, LNK306 etc IC controllers; circuit can be different from FIG. 2 when other controllers or topologies are used, control circuit 209 can use any kind of controller, IC or discrete components.

8. An AC-to-DC voltage converter as power supply for lamp according to claim 1, wherein the control circuit 209 can use controller with PFC or without PFC function; PFC function is power factor correction that makes input voltage and current in phase and power factor is near to 1.

9. An AC-to-DC voltage converter as power supply for lamp according to claim 1, wherein the feedback and dimming circuit 205 change the ratio between feedback voltage and interior reference voltage by changing potentiometer resistance value to change voltage on output lamp, the circuit can be realized by different circuits, any one of R6, R12, R15 can be potentiometer or can be removed; Opto-coupler or auxiliary winding can be used for feedback or feedback signal directly comes from lamp, transistor can be combined with opto-coupler or auxiliary winding for feedback, one implementation with opto-coupler feedback and dimming is shown in FIG. 5, cathode of opto-diode is connected to secondary ground while emitter of opto-transistor is connected to primary ground, point 1 can be connected with Vo, point 2 can be connected with a constant predetermined voltage such as reference voltage, regulator voltage, constant supply voltage etc, point 3 can be connected with feedback pin or Vsense pin etc as feedback, R15 is a potentiometer, R6,R31 are resistors, R6 or R31 can be a potentiometer while others are resistors.

10. An AC-to-DC voltage converter as power supply for lamp according to claim 1, wherein the filter 202, 204, 214 remove high frequency signal and prevents high frequency signal from entering power source or power system and lamp 211, any filter can be used such as LC filter, CLC π filter, common mode filter, differential mode filter etc, any one of 202,204,214 can be removed.

11. An AC-to-DC voltage converter as power supply for lamp according to claim 1, wherein the start circuit 208 supply power to control circuit 209 to start and is reverse biased after stable operation then biasing circuit 212 supply power to control circuit 209 or can supply power from very beginning to stable operation, any circuit can be used as start circuit 208 such as linear regulator or valley-filled circuit etc

12. An AC-to-DC voltage converter as power supply for lamp according to claim 1, wherein the circuit board is installed in a metal lamp stand to shield electromagnetic radiation to minimum level and the circuit board can also be installed in other material lamp stand.

13. An AC-to-DC voltage converter as power supply for lamp according to claim 1, wherein the control circuit 209 can be combined with main switch in converter 206 to one integrated circuit as in Tiny Switch series controller, TOPSwitch series controllers, PeakSwitch series controllers etc from power integration Inc, VIPer series controllers etc from ST electronics, IRIS series controllers etc from International Rectifier company etc.

14. An AC-to-DC voltage converter as power supply for lamp according to claim 1, wherein the control circuit 209 can change the frequency or duty cycle of main switch, or can fix the frequency as in VIPER series IC controllers or use pulse train control, smart skip mode control, DSP or other methods etc.

15. An AC-to-DC voltage converter as power supply for lamp according to claim 1, wherein the input monitor circuit 213 can be removed as in TEA 1506 controller from Philips semiconductor, AND8099/D etc from ON semiconductor, FSDM311 controller etc from Fairchild semiconductor, IRIS series from International Rectifier company or TinySwitch series, TOPSwitch series, PeakSwitch series controllers etc.

16. An AC-to-DC voltage converter as power supply for lamp according to claim 1, wherein the feedback can use opto-coupler as feedback as the following: A voltage reference is in series with optodiode and potentiometer; the collector of opto transistor is in series with FB pin or reference voltage; or voltage reference with a voltage divider composed of potentiometer and resistor to set output voltage, the voltage reference is in series with opto-diode, the opto transistor is in series with pin for feedback.

17. An AC-to-DC voltage converter as power supply for lamp according to claim 1, wherein the rectifier 203 can include one or two or more rectifiers and can use any circuit as rectifier, full bridge rectifier, half bridge rectifier, 2 diodes, 4 diodes or bridgeless PFC etc.

18. An AC-to-DC voltage converter as power supply for lamp according to claim 1, wherein the start circuit 208 can be removed or can be combined with part of other circuit into one integrated circuit.

19. An AC-to-DC voltage converter as power supply for lamp according to claim 1, wherein the output can also have load as adaptor, charger, TV power supply, LCD, OLED, any OLED etc, it is can also be used for bus AC to DC converter, PFC converter, PFC converter for lighting, computer power supply, monitor power supply, notebook adapter, LCD TV, AC/DC adapter, battery charger, power tool charger, electronic ballast, video game power supply, router power supply etc.

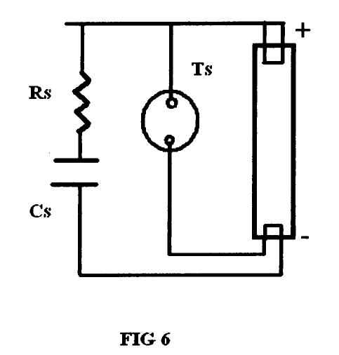

20. An AC-to-DC voltage converter as power supply for lamp according to claim 1, wherein the converter can combine with starter to start fluorescent, compact lamp etc, one implementation is using a starter in parallel with lamp, resistor Rs and Capacitor Cs delay voltage change, Ts is the trigger to connect the cathode filament, after lamp start, voltage goes down and Ts disconnect the cathode filament, Rs is connected to lamp anode side, Cs is connected to lamp cathode side that is shown in FIG. 6.
